(19) United States
(12) Patent Application Publication
(10) Pub. No.: US 2024/0328875 A1
(43) Pub. Date: Oct. 3, 2024

(54) STRAIN DETECTION DEVICE

(71) Applicant: Japan Display Inc., Tokyo (JP)

(72) Inventors: Fumihoru NAKANO, Tokyo (JP); Toshinori UEHARA, Tokyo (JP)

(21) Appl. No.: 18/612,397

(22) Filed: Mar. 21, 2024

(30) Foreign Application Priority Data
Apr. 3, 2023 (JP) 2023-060401

(51) Int. Cl. G01L 1/22

(52) U.S. Cl. CPC G01L 1/2287; G01L 1/225

(57) ABSTRACT

According to one embodiment, a strain detection device includes a sensor sheet including strain gauges, power lines and first signal lines each connected to one end side of a respective one thereof, and ground lines and second signal lines each connected to an other end side of the respective one thereof, and a controller including a selector which sequentially scan-drives the strain gauges via the power lines and sequentially reads detection signals at the one end side of the respective strain gauges and detection signals at the other end side via the first and second signal lines, an arithmetic processor which calculates a radius of curvature based on the detection signals, and a determination unit which determines whether to stop or continue scan-driving of the strain gauges.

### CROSS-REFERENCE TO RELATED APPLICATIONS

This application is based upon and claims the benefit of priority from Japanese Patent Application No. 2023-060401, filed Apr. 3, 2023, the entire contents of which are incorporated herein by reference.

### FIELD

Embodiments described herein relate generally to a strain detection device.

### BACKGROUND

As an example of the strain detection device, a flexible film-like or sheet-like strain gauge sensor is known. Such a strain gauge sensor includes a plurality of strain gauges provided side by side on a surface of a strip-shaped flexible sheet substrate and a plurality of signal lines for supplying current to these strain gauges. By wrapping the strain gauge sensor around a curved sample object and detecting the change in resistance of each strain gauge, the curved shape of the sample object can be detected.

In order to reduce power consumption and the number of wiring lines in such a strain gauge sensor, a technique of driving a plurality of strain gauges in a time-division manner has been proposed. In this manner, in the strain gauge sensor, the power consumption and the number of wiring lines can be reduced; however, the detection time to obtain one curved surface information is prolonged.

### BRIEF DESCRIPTION OF THE DRAWINGS

FIG. 1 is a perspective view showing a strain gauge sensor device according to the first embodiment.

FIG. 2 is a longitudinal cross-sectional view of the strain gauge sensor device.

FIG. 3 is a development view schematically showing gauge patterns and wiring patterns of first sensor sheets and second sensor sheets of the strain gauge sensor device.

FIG. 4 is a block diagram of a controller of the strain gauge sensor device.

FIG. 5 is a block diagram of the first sensor sheets and second sensor sheets, a selector and an analog front end of the controller.

FIG. 6 is a circuit diagram of a difference detection circuit in the analog front end.

FIG. 7 is a schematic side view of the strain gauge sensor device installed on the surface of a sample object.

FIG. 8 is a diagram showing grouping and driving order of strain gauges when scanning and driving the strain gauges.

FIG. 9A is a flowchart showing detection operation of the strain gauge sensor device.

FIG. 9B is a flowchart showing the detection operation of the strain gauge sensor device.

FIG. 10 is a timing chart during the detection operation of the strain gauge sensor device when a radius of curvature is small.

FIG. 11 is a timing chart during the detection operation of the strain gauge sensor device when the radius of curvature is large.

FIG. 12 is a side view schematically showing the strain gauge sensor device in a state where the strain gauges of Group 1 are scan-driven.

FIG. 13 is a diagram schematically showing a part of the strain gauge sensor device in a state where it is placed on a surface of a sample object.

FIG. 14 is a circuit diagram equivalent to the first sensor sheets and the second sensor sheets.

FIG. 15 is a development diagram of the strain gauge sensor device, which illustrates the scanning operation during detection.

FIG. 16 is a side view schematically showing the strain gauge sensor device in a state where the strain gauges of Groups 1 and 2 are scan-driven.

FIG. 17 is a side view schematically showing the strain gauge sensor device in a state where the strain gauges of Groups 1, 2, and 3 are scan-driven.

FIG. 18 is a side view schematically showing the strain gauge sensor device in a state where the strain gauges of Groups 1 to 4 are scan-driven.

FIG. 19 is a diagram showing the grouping and driving order of the strain gauges when they are scan-driven according to the first modified example.

FIG. 20 is a side view schematically showing the strain gauge sensor device according to the second modified example.

FIG. 21 is a side view showing an example of a sample object.

FIG. 22 is a perspective view of a strain gauge sensor device according to the second embodiment.

FIG. 23 is a block diagram showing sensor sheets and a controller of the strain gauge sensor device according the second embodiment.

### DETAILED DESCRIPTION

Various embodiments will be described hereinafter with reference to the accompanying drawings. In general, according to one embodiment, a strain detection device comprises a sensor sheet comprising a plurality of strain gauges provided in a row at intervals, a plurality of power lines and a plurality of first signal lines each connected to one end side of a respective one of the plurality of strain gauges, and a plurality of ground lines and a plurality of second signal lines each connected to an other end of side the respective one of the plurality of strain gauges; and
a controller comprising a selector which sequentially scan-drives the plurality of strain gauges via the plurality of power lines and sequentially reads detection signals at the one end side of the respective strain gauges and detection signals at the other end side of the respective strain gauges via the first signal lines and the second signal lines, an arithmetic processor which calculates a radius of curvature based on the detection signals, and a determination unit which determines whether to stop or continue scan-driving of the strain gauges based on the radius of curvature.

Note that the disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings show schematic illustration rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

### First Embodiment

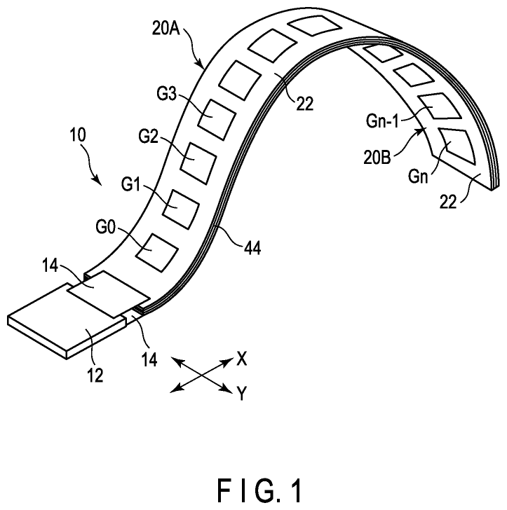

As an example of the strain detection devices, a strain gauge sensor device according to an embodiment will be described in detail. FIG. 1 is a perspective view of the strain gauge sensor device of the first embodiment.

As shown in the figure, the strain gauge sensor device 10 is configured as a double-sided strain gauge sensor. The strain gauge sensor device 10 comprises an elongated strip-shaped flexible base substrate 44 that functions as a base material, a first sensor sheet 20A provided on a first main surface (front side) of the base substrate 44, a second sensor sheet 20B provided on a second main surface (rear side) of the base substrate 44, a pair of flexible wiring boards (FPC) 14 and a relay board (drive circuit board) 12 connected to the first sensor sheet 20A and the second sensor sheet 20B via the pair of flexible circuit boards 14. In one example, the base substrate 44 is formed of a resin such as polyethylene terephthalate (PET), polyimide, or the like, to have a thickness of about 0.3 to 0.5 mm.

Each of the first sensor sheet 20A and the second sensor sheet 20B includes an elongated strip-shaped flexible sheet base material 22 and a conductor pattern provided on one side of the sheet base material 22. The conductor pattern includes a plurality of strain gauges G0 to Gn. The plurality of strain gauges G0 to Gn are provided in a row with predetermined intervals therebetween from one end to the other end of the sheet base material 22 along the longitudinal direction X.

In the figure, the longitudinal direction X and the width direction Y of the sensor sheet are two directions orthogonal to each other. These directions may intersect at an angle other than 90 degrees.

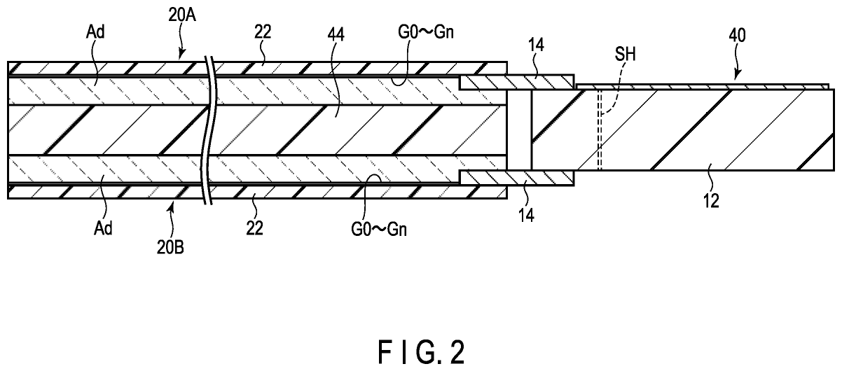

FIG. 2 is a longitudinal cross-sectional view of the strain gauge sensor device 10.

As shown in FIG. 2, the base substrate 44 includes a front surface and a back surface. In one example, the first sensor sheet 20A on the surface where the conductor patterns (G0 to Gn) are provided is attached to the front surface of the base substrate 44 by an adhesive layer Ad such as a transparent adhesive sheet (OCA). The second sensor sheet 20B on the surface where the conductor patterns (G0 to Gn) are provided is attached to the back surface of the base substrate 44 by the adhesive layer Ad.

The relay substrate 12 includes a drive circuit 40 and a plurality of wiring lines on one surface side and a plurality of wiring lines, which are not shown, on the other side. The conductor patterns of the first sensor sheet 20A are connected to the wiring lines provided on an upper surface side of the relay substrate 12 via the FPC 14. Similarly, the conductor patterns of the second sensor sheet 20B are connected to the wiring lines provided on a lower surface side of the relay substrate 12 via the FPC 14.

Note that the first sensor sheet 20A and the second sensor sheet 20B may be configured to be attached to the front and back sides of the base substrate 44 by the adhesive layer Ad on the side of the sheet base material 22.

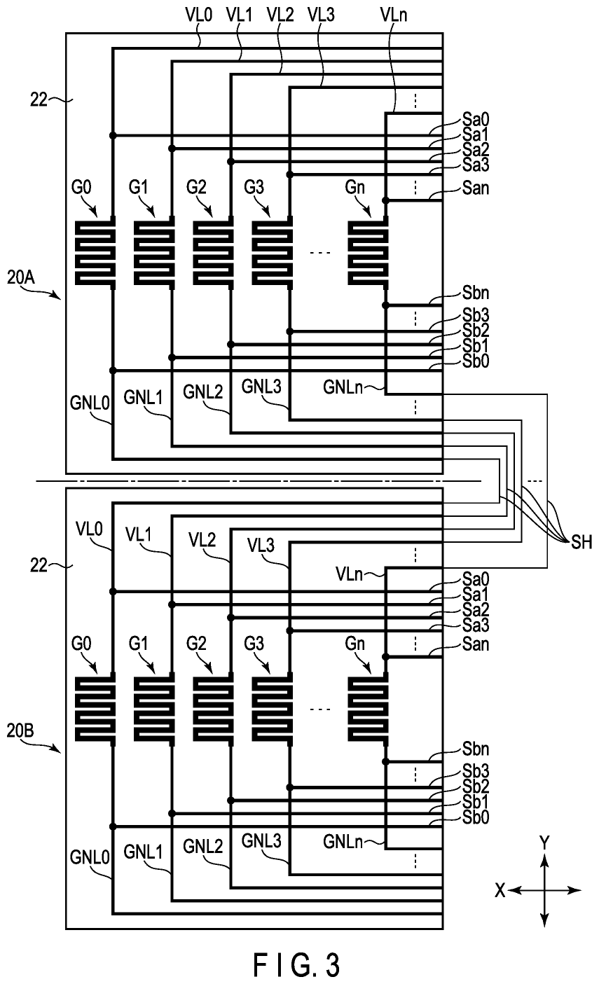

FIG. 3 is a plan view schematically showing the strain gauges and wiring patterns of the first sensor sheet 20A and the second sensor sheet 20B in a state where the first sensor sheet 20A and the second sensor sheet 20B are developed. As shown in the figure, according to this embodiment, the first sensor sheet 20A and the second sensor sheet 20B are configured to have the identical shapes, dimensions, and conductor patterns. In detail, each of the first sensor sheet 20A and the second sensor sheet 20B has a flexible strip-shaped sheet base material 22 and a conductor pattern provided on one side of the sheet base material 22. The conductor patterns include a plurality of strain gauges G0 to Gn. The plurality of strain gauges G0 to Gn are arranged in a row with intervals therebetween along the longitudinal direction X from one end (distal end) to the other end (proximal end) of the sheet base material 22. Each of the strain gauges G0-Gn extends in a bellows fashion along the width direction Y and includes one end and the other end along the width direction Y. Each of the strain gauges G0 to Gn produces a change in resistance in response to the respective strain thereof.

The conductor patterns include a plurality of power lines VL0 to VLn, a plurality of ground lines GNL0 to GNLn, a plurality of first signal lines Sa0 to San, and a plurality of second signal lines Sb0 to Sbn, extending in the longitudinal direction X along rows of the strain gauges G0 to Gn, respectively.

The power supply lines VL0 to VLn are located on a one end side of the strain gauges G0 to Gn. The power supply lines VL0 to VLn include respective one ends connected to, on the one end side, the strain gauges G0 to Gn and the other ends located on the proximal end side of the sheet base material 22, and they extend approximately parallel to each other.

The first signal lines Sa0 to San are located between one end side of the strain gauges G0 to Gn and the power supply lines VL0 to VLn. The first signal lines Sa0 to San include respective one ends connected to the strain gauges G0 to Gn and the other ends located on the proximal end side of the sheet base material 22, and they extend approximately parallel to each other.

The ground lines GNL0 to GNLn are located on the other end side of the strain gauges G0 to Gn. The ground lines GNL0 to GNLn include respective one ends connected to the other ends of the strain gauges G0 to Gn and the other ends located on the proximal end side of the sheet base material 22, and they extend approximately parallel to each other.

The second signal lines Sb0 to Sbn are located between the other ends of the strain gauges G0 to Gn and the ground lines GNL0 to GNLn. The second signal lines Sb0 to Sbn include respective one ends connected to the other ends of the strain gauges G0 to Gn and the other ends located at on proximal end of the sheet base material 22, and they extend approximately parallel to each other.

The first sensor sheet 20A and the second sensor sheet 20B configured as described above are attached to the front and rear surfaces of the base substrate 44 and oppose each other while interposing the base substrate 44 therebetween. That is, the strain gauges G0-Gn of the first sensor sheet 20A oppose the strain gauges G0-Gn of the second sensor sheet 20B, respectively, while interposing the base substrate 44 therebetween. Here, it is preferable that each of the strain gauges G0 to Gn of the first sensor sheet should overlap at least partially each respective one of the strain gauges G0 to Gn of the second sensor sheet in a plan view viewed from a direction perpendicular to the surface of the base substrate 44. Alternatively, it is preferable that the strain gauges G0 to Gn of the sensor sheets 20A and 20B should at least overlap each other, respectively, without being displaced in the width direction Y while tolerating displacement in the longitudinal direction X. Alternatively, the strain gauges G0 to Gn of the sensor sheets 20A and 20B should preferably overlap respectively each other without being displaced in the longitudinal direction X or in the width direction Y.

The ground lines GNL0 to GNLn of the first sensor sheet 20A extend via the FPC 14 to the upper surface of the relay substrate 12. The power lines VL0 to VLn of the second sensor sheet 20B extend via the FPC 14 over to the back surface of the relay substrate 12. In this embodiment, the ground lines GNL0 to GNLn of the first sensor sheet 20A are electrically connected respectively to the power lines VL0 to VLn of the second sensor sheet 20B at the position of the relay substrate 12. As shown in FIG. 2, the ground lines GNL0 to GNLn and the power supply lines VL0 to VLn are connected respectively to each other by plated through holes SH as connection lines formed on the relay substrate 12.

Note that the connection lines are not limited to plated-through holes SH, but can as well be formed by using wiring patterns on the relay substrate 12 or the like. Further, it is also possible to adopt such a configuration that the FPC 14 on the side of the second sensor sheet 20B is connected to the upper surface side of the relay substrate 12, and thereby, the ground lines GNL0 to GNLn of the first sensor sheet 20A are connected respectively to the power lines VL0 to VLn of the second sensor sheet 20B via wiring lines on the relay substrate 12 in place of plated through holes. Further, such a configuration may as well be adopted that the FPC 14 on the first sensor sheet 20A and the FPC 14 on the second sensor sheet 20B are connected to the drive circuit 40 provided on the upper surface side of the relay substrate 12, and thereby the ground lines GNL1 to GNLn of the first sensor sheet 20A are connected respectively to the power supply lines VL1 to VLn of the second sensor sheet 20B in the drive circuit 40.

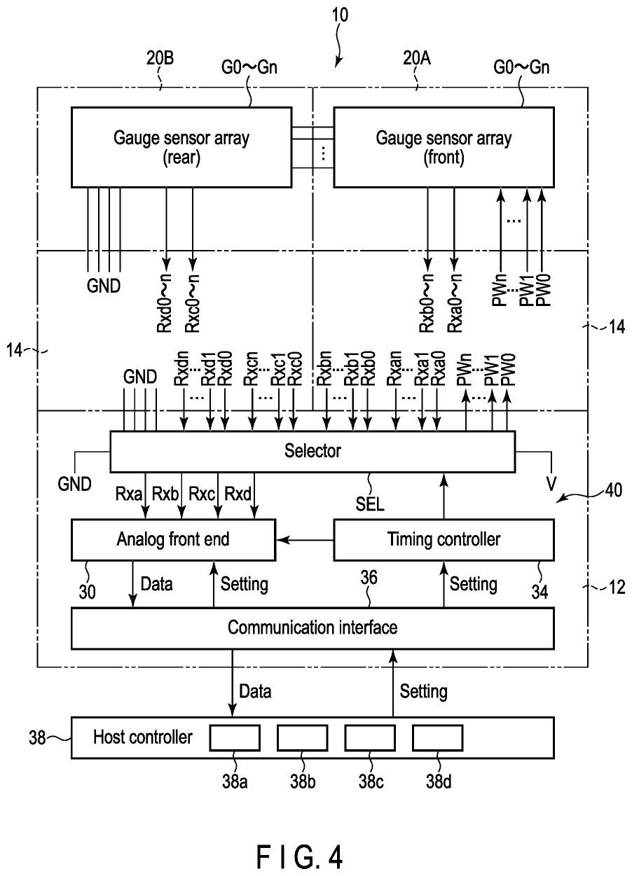

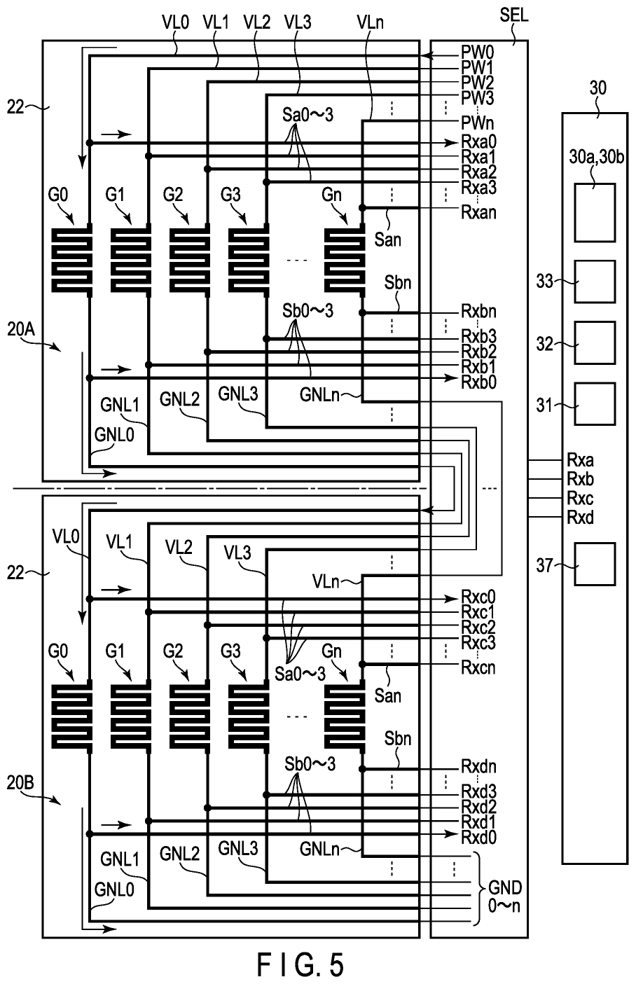

Next, the driving circuit (controller) that drives the first sensor sheet 20A and the second sensor sheet 20B configured as described above will be described. FIG. 4 is a block diagram schematically showing the drive circuit of the strain gauge sensor device 10, and FIG. 5 is a block diagram showing the first sensor sheets and the second sensor sheets, the selector and analog front end of the controller.

As shown in FIG. 4, the drive circuit 40 provided on the relay substrate (control circuit board) 12 includes a selector SEL, an analog front end (AFE: signal adjustment circuit) 30, a timing controller 34, a communication interface 36 and the like.

The communication interface 36 is connected to the external host controller 38 via wire or wirelessly and receives drive signals (setting) from the host controller 38 and transmits detection data (Data) to the host controller 38.

The timing controller 34 outputs drive signals to the selector SEL and the analog front end 30 according to the drive signals (setting).

The selector SEL is constituted by a plurality of shift registers, multiplexers and the like. The selector SEL connects the power supply lines VL0 to VLn of the first sensor sheet 20A sequentially to the power supply and applies voltages to the strain gauges G0 to Gn sequentially according to the drive signals from the timing controller 34. In synchronization with this, the selector SEL sequentially reads the detection signals (voltage values) RXa0 to RXan and RXb0 to RXbn at one end side and the other end side of each of the strain gauges G0 to Gn via the respective one of the first signal lines Sa0 to San and the second signal lines Sb0 to Sbn. Further, the selector SEL sequentially reads the detection signals (voltage values) RXc0 to RXcn and RXd0 to RXdn at the one end side and the other end side of each of the strain gauges G0 to Gn via the respective one of the first signal lines Sa0 to San and the second signal lines Sb0 to Sbn on the second sensor sheet 20B, in synchronization with the reading described above.

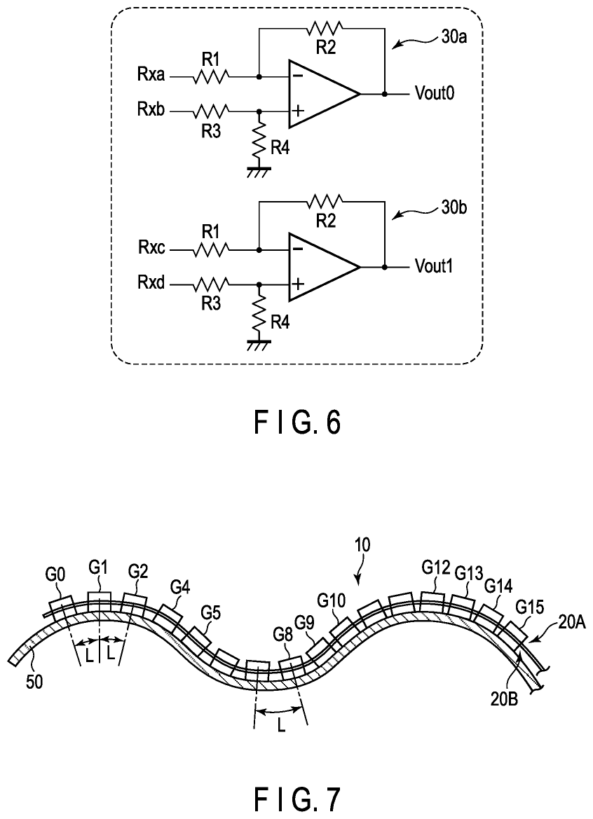

As shown in FIG. 5, the analog front end 30 includes a read circuit 31, a difference detection circuits 30a and 30b, an AD converter 32, a digital filter 33, a memory 37 and the like. FIG. 6 is a circuit diagram of the difference detection circuit. As shown in the figure, the analog front end 30 includes a difference detection circuit (subtraction circuit) 30a that processes the detection signals of the first sensor sheet 20A and a difference detection circuit (subtraction circuit) 30b that processes the detection signals of the second sensor sheet 20B. The analog front end 30 adjusts (amplification, AD conversion, filtering) the detection signals RXa and RXb and detection signals RXc and RXd of each of the strain gauges G0 to Gn sent from the selector SEL according to the drive signals, and outputs them to the communication interface 36. At this time, since the voltage drop value of each strain gauge G is required to calculate the radius of curvature, the difference between the detection values Rxa and Rxb of the strain gauges G0 to Gn, respectively, and the difference between the detection values Rxc and Rxd of the strain gauges G0 to Gn, respectively, is taken by the difference detection circuit 30a and 30b for signal output.

As shown in FIG. 4, the host controller 38 includes a read circuit 38a, a memory 38b, an arithmetic processing unit 38c, and a determination unit 38d. The read circuit 38a reads the output signal (differential data) sent from the communication interface 36 and stores it in the memory 38b. The arithmetic processing unit 38c, for example, CPU, performs arithmetic operations such as data forming, curved surface calculation and the like, based on the difference data so as to calculate the strain (radius of curvature), curved surface form (curved surface coordinates) and the like of the sample object detected by the first and second sensor sheets 20A and 20B. The determination unit 38D judges whether to continue or stop the scan drive according to the detected values. The memory 38b stores the differential data, the calculated radius of curvature, and the curved surface form, and in addition, the threshold value used for judgment, the detection operation program and the like. Next, the detection operation mode of the strain gauge sensor device 10 will be described.

FIG. 7 is a diagram schematically illustrating the state in which the strain gauge sensor device is installed on the surface of a sample object. As shown in the figure, in one example, the sample object 50 includes a wavy or sine-wavy curved surface. The strain gauge sensor device 10 is installed on the surface of the sample object 50 to detect the curved surface form of the sample object 50. In this case, the strain gauge sensor device 10 is installed in such a state that the second sensor sheet 20B is in contact with the surface of the sample object 50. In one example, it is assumed that the first sensor sheets 20A and the second sensor sheets 20B each comprise sixteen strain gauges G0 to G15. The distance L between each adjacent pair of the strain gauges is, for example, 5 to 20 mm, more preferably 10 to 15 mm.

According to this embodiment, the strain gauge sensor device 10 divides all the strain gauges G0 to G15 into two or more groups, and executes curved surface detection in the so-called thinned-out scan operation mode, in which the detection values are acquired by scanning (time-division driving) multiple strain gauges for each group.

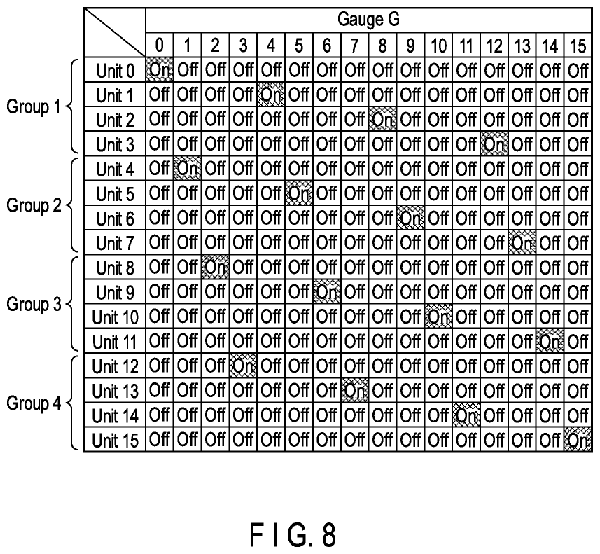

FIG. 8 is a diagram showing the grouping and driving order of the strain gauges when they are scan-driven. As shown in the figure, in this embodiment, the sixteen strain gauges are divided into four groups 1 to 4, and each group contains four strain gauges. These four strain gauges are strain gauges located at equal intervals therebetween from each other, for example, apart from each other by four strain gauges (4 L).

Group 1 contains strain gauges G0, G4, G8, and G12 corresponding to Units 0 to 3, respectively. Group 2 contains strain gauges G1, G5, G9, and G13 corresponding to Units 4 to 7, respectively. Group 3 contains strain gauges G2, G6, G10, and G14 corresponding to Units 8 to 11, respectively. Group 4 contains strain gauges G3, G7, G11, and G15 corresponding to Units 12 to 15, respectively.

Note that the number of groups to be divided is not limited to four, but can be set to any number of two or more. The number of strain gauges in each group is not limited to a common number, but may be different from one group to another. In each group, the interval between strain gauges should preferably be set to the widest interval possible, and should preferably be set to be apart from each other by two strain gauges (2 L) or more. Although the intervals between these strain gauges are set to equal intervals, but they do not have to be equal.

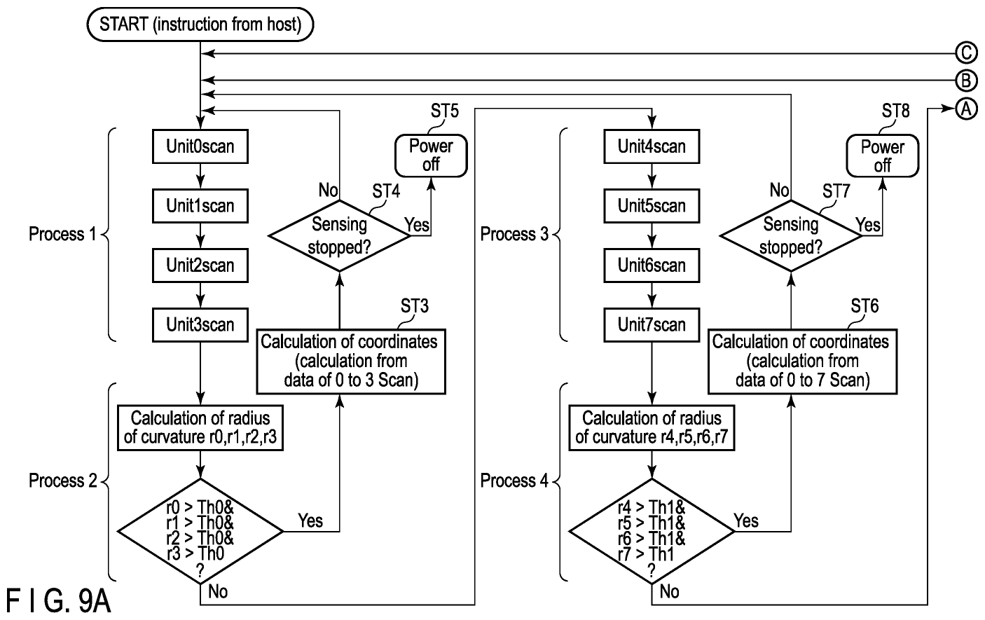

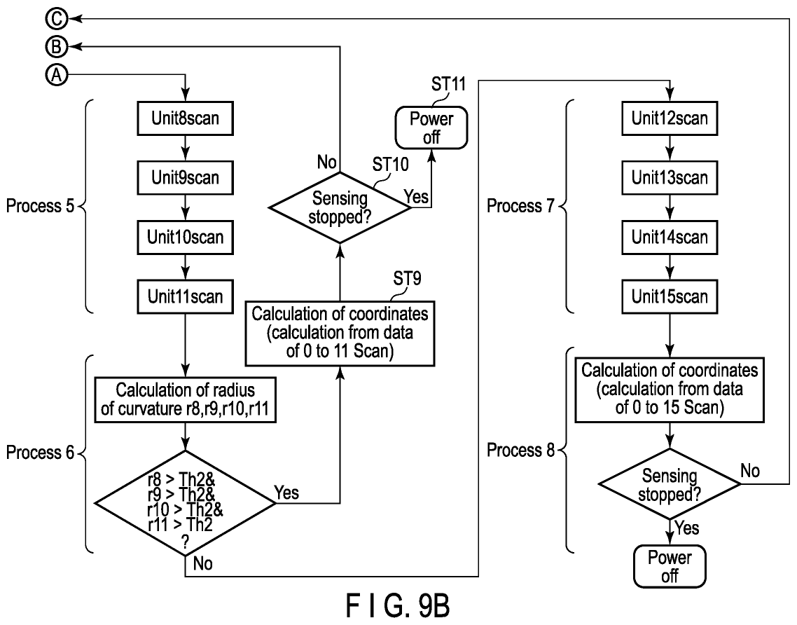

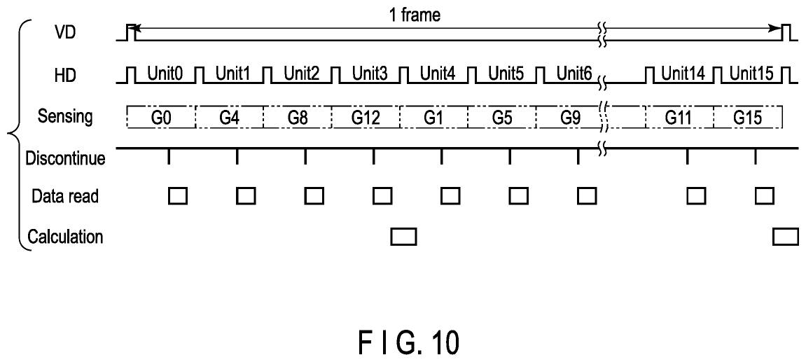

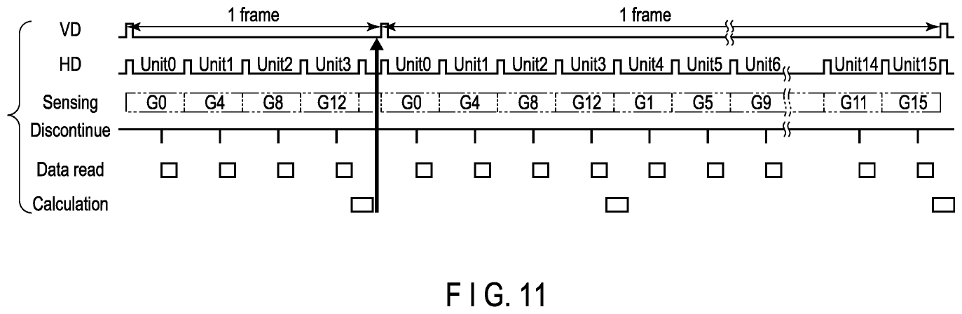

FIGS. 9A and 9B are flowcharts each showing the detection operation of the strain gauge sensor system. FIG. 10 is a timing chart during the detection operation of the strain gauge sensor device when the radius of curvature of the sample object is small, and FIG. 11 is a timing chart during the detection operation of the strain gauge sensor device when the radius of curvature of the sample object is large.

As shown in the figure, during the detection, the timing controller 34 inputs the start signal VD and the clock signal HD synchronized therewith to the selector SEL in response to an instruction from the host controller 38. The selector SEL sequentially scan-drives (sets) strain gauges G0 (Unit 0), G4 (Unit 1), G8 (Unit 2), and G12 (Unit 3) of Group 1 and sequentially reads the detection signals (voltage values) of these strain gauges (Process 1).

In detail, as shown in FIG. 5, the selector SEL applies a power voltage to the power line VL0 of the first sensor sheet 20A and applies a desired voltage PW0 to the strain gauge G0. As a result, a current I is allowed to follow in the strain gauge G0 for a certain period of time. At the same time, the selector SEL reads the detection signal (voltage value) RXa0 at one end of the strain gauge G0 and the detection signal (voltage value) RXb0 at the other end of the strain gauge G0 via the first signal line Sa0 and the second signal line Sb0.

The ground line GNL0 of the first sensor sheet 20A is connected to the power line VL0 of the second sensor sheet 20B. More specifically, the strain gauge G0 of the first sensor sheet 20A and the strain gauge G0 of the second sensor sheet 20B are connected in series via the ground line GNL0 of the first sensor sheet 20A, the connection line (plated through hole) and the power line VL0 of the second sensor sheet 20B. Therefore, when the strain gauge G0 of the first sensor sheet 20A is scan-driven, the strain gauge G0 of the second sensor sheet 20B is driven synchronously, and the current I is also allowed to flow in the strain gauge G0. At the same time, the selector SEL acquires the detection signal (voltage value) RXc0 at one end of the strain gauge G0 and the detection signal (voltage value) RXd0 at the other end of the strain gauge G0 via the first signal line Sa0 and the second signal line Sb0 of the second sensor sheet 20B.

The detection signals RXa0, RXb0, RXc0, and RXd0 thus acquired are sent to the analog front end 30, where they are adjusted and differentially detected and then stored in the memory 37.

Thereafter, in a manner similar to that discussed above, the selector SEL sequentially scan-drives the strain gauges G4, G8, and G12 of the first sensor sheets 20A and the second sensor sheets 20B, and sequentially acquires the detection signals (voltage values) of these strain gauges RXa4, RXb4, RXc4, RXd4, RXa8, RXb8, RXc8, RXd8, RXa12, RXb12, RXc12 and RXd12. The detection signals RXa, RXb, RXc, and RXd thus acquired are sent to the analog front end 30, where they are adjusted and differentially detected and then stored in the memory 37.

As described above, the analog front end 30 reads the sent RXa0 to RXal2, RXb0 to RXb12, and the detection signals RXc0 to RXc12 and RXd0 to RXd12 sequentially by the read circuit 31 and converts them to voltage signals, and further converts them to digital data (Data) by the AD converter 32 and the digital filter 33. Further, the analog front end 30 detects the difference between the detection signals RXa0 to RXa12 and RXb0 to RXb12 and the difference between the detection signals RXc0 to RXc12 and RXd0 to RXd12 by the difference detection circuits 30a and 30b. The detected differential data are sequentially stored in the memory 37. The analog front end 30 reads the differential data for one frame from the memory 37 and outputs it to the host controller 38 at the time when the scan driving of the strain gauges of Group 1 is completed.

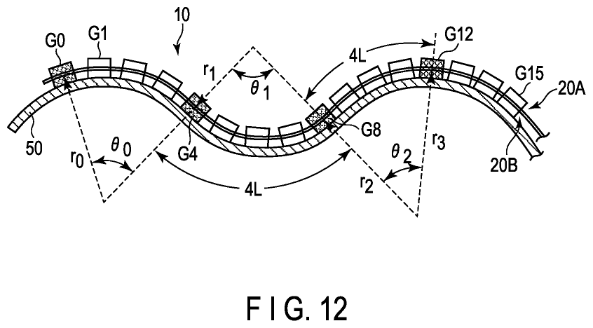

FIG. 12 is a diagram schematically showing the strain gauge sensor device in a state where the strain gauges G0, G4, G8, and G12 of Group 1 are scan-driven. As shown in FIG. 9A and FIG. 12, the read circuit 38a of the host controller 38 sends the differential data to the read arithmetic processing unit 38c. The arithmetic processing unit 38c calculates the radii of curvature, r0, r1, r3, and r4 of the sites detected by the strain gauges G0, G4, G8, and G12 based on the sent differential data (Process 2). The calculation results are stored in the memory 38b.

Here, an example of the method of calculating the radius of curvature will be described.

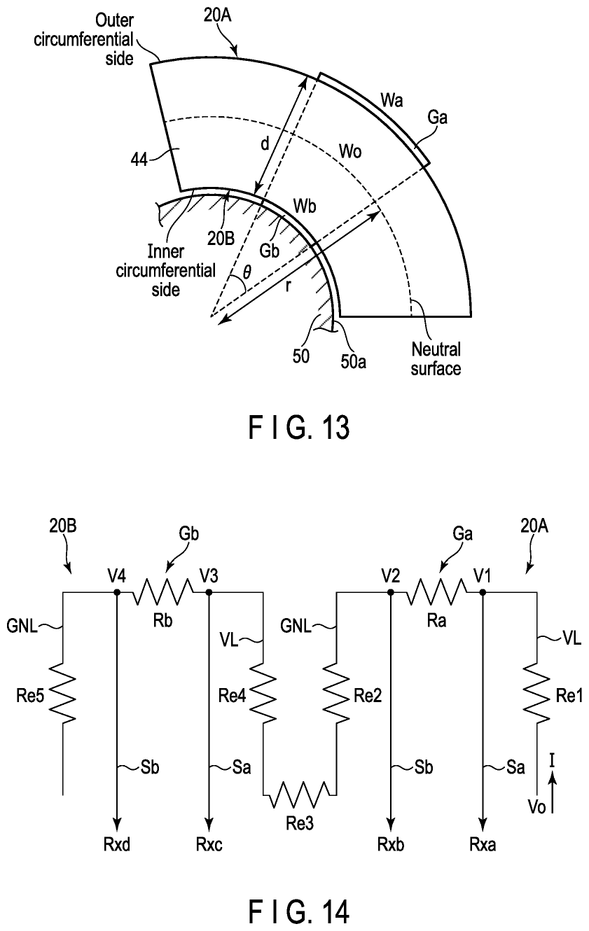

FIG. 13 is a diagram schematically illustrating a part of the strain gauge sensor device installed on the surface 50a of the sample object 50 described above. As shown in the figure, when installed on the surface 50a, the neutral surface of the base substrate 44 is curved at the same radius of curvature, r, as that of the surface 50a. Here, the neutral surface is a surface where neither elongation (tension) nor contraction (compression) occurs before and after the curvature of the strain gauge sensor device (that is, zero strain even after curvature). In this embodiment, the neutral surface is located at the center (thickness×½) of the base substrate 44 in the thickness direction.

The strain gauges Ga of the first sensor sheet 20A, which are located on an outer circumferential side and the strain gauges Gb of the second sensor sheet 20B, which are located on an inner circumferential surface oppose each other, respectively, in the radial direction and are curved at radii of curvature different from each other.

In FIG. 13 and the formulas provided below, the symbols are designated as follows, W0: initial width of strain gauge, Wa: strain gauge width on the outer circumferential side, Wb: strain gauge width on the inner circumferential side, ΔW: strain gauge change width, d: substrate thickness, θ: strain gauge opening angle, r: radius of curvature of neutral surface, k: gauge ratio, R0: strain gauge reference resistance, and ΔR: strain gauge resistance change.

When the width of the strain gauge G in the neutral surface of the base substrate 44 is designated as the initial width W0 of the strain gauge, then W0=re is established. The outer strain gauge Ga on the outer circumferential side is deformed into an extended state by curving, and its gauge width Wa is expressed by:

$${W}_{a} = ( r + \frac{d}{2} ) θ = {W}_{0} + Δ W .$$

The inner strain gauge Gb on the inner circumferential side is deformed into a contracted state by curving, and its gauge width Wb is expressed by:

$${W}_{b} = ( r - \frac{d}{2} ) θ = {W}_{0} - Δ W .$$

The change in width ΔW is ΔW=dθ/2. The radius of curvature, r, of the neutral surface (corresponding to the surface 50a of the sample object) is expressed by:

$$r = \frac{{W}_{0}}{θ} = \frac{d}{2} \frac{{W}_{0}}{Δ W} = \frac{kd}{2} \frac{{R}_{0}}{Δ R} . \qquad ( 1 )$$

FIG. 14 is a diagram schematically showing an equivalent circuit of the first sensor sheet 20A and the second sensor sheet 20B.

As shown in the figure, according to this embodiment, the ground lines GNL of the first sensor sheet 20A are connected to the power lines VL of the second sensor sheet 20B, that is, they are short-circuited. In this manner, the strain gauges Ga on the outer circumferential side and the strain gauges Gb on the inner circumferential side are connected in series. During the strain detection, the voltage drop is measured at one end and the other end of each of the strain gauges Ga and Gb.

The initial resistance of each of the strain gauges Ga and Gb before deformation is designated as R0, the resistance of the strain gauges Ga on the outer circumferential side after deformation is designated as Ra, the resistance of the strain gauge Gb on the inner circumferential side after deformation is designated as Rb, the voltage values at one end and the other end of the strain gauge Ga on the outer circumferential side are designated as V1 and V2, respectively, the voltage values at one end and the other end of the strain gauge Gb on the inner circumferential side are designated as V3 and V4, respectively, the change in resistance of the strain gauges is designated as ΔR, and the current flowing through each of the strain gauges Ga and Gb is designated as I, then the voltage drop V12 between one end and the other end of the strain gauge Ga, and the voltage drop V34 between one end and the other end of the strain gauge Gb are expressed by:

$$\begin{matrix}{V}_{12} = {V}_{1} - {V}_{2} + {R}_{a} I \\ {V}_{34} = {V}_{3} - {V}_{4} = {R}_{b} I\end{matrix} .$$

Here, when the above equation is divided by the below equation, the following relationship is obtained:

$$\frac{{V}_{12}}{{V}_{34}} = \frac{{R}_{a}}{{R}_{b}} .$$

When the relationship is expressed using the change in resistance of the strain gauge, the following equation can be obtained.

$$\frac{{V}_{12}}{{V}_{34}} = \frac{{R}_{0} - Δ R}{{R}_{0} + Δ R} .$$

From the above-provided formula, the change rate of the resistance of the strain gauges is calculated by the following equation.

$$\begin{matrix}( \frac{{V}_{12}}{{V}_{34}} - 1 ) {R}_{0} - ( \frac{{V}_{12}}{{V}_{34}} + 1 ) Δ R = 0 \\ \frac{Δ R}{{R}_{0}} = \frac{{V}_{12} - {V}_{34}}{{V}_{12} + {V}_{34}}\end{matrix} .$$

When the above-provided relational equation is applied to the above-provided formula (1) for the radius of curvature, r, the following equation is obtained.

$$r = \frac{k d}{2} \frac{{R}_{0}}{Δ R} = \frac{kd}{2} \frac{( {V}_{12} + {V}_{34} )}{( {V}_{12} - {V}_{34} )} . \qquad ( 2 )$$

The arithmetic processing unit 38c of the host controller 38 can calculate the radius of curvature, r, of the detection site by the acquired differential values (V12, V34) and the above-provided formula (2).

As shown in FIG. 9A, after the radii of curvature, r0, r1, r2, and r3 are calculated, the determination unit 38d of the host controller 38 compares each of the absolute values of the calculated radii of curvature, r0, r1, r3, and r4 with the predetermined threshold value th0 and determines whether to continue or stop scan-driving according to the size relationship in terms of which is greater or smaller (Process 2). In one example, when at least one of the absolute values of the curvature radii r0, r1, r3, and r4 is smaller than the threshold value th0, the host controller 38 instructs the drive circuit 40 to sequentially scan-drive the strain gauges of the next group, Group 2. Alternatively, when the absolute values of all the curvature radii r0, r1, r3, and r4 are greater than the threshold value th0, the arithmetic processing unit 38c calculates the curved surface form (curved surface coordinates) of the entire surface of the sample object 50 based on the curvature radii r0, r1, r3, and r4. More specifically, the absolute values and positive/negative signs of each of the radii of curvature r0, r1, r3, and r4 obtained by the above-provided formula (2), as well as the interval L between strain gates, are used to obtain the rotation angle between the strain gauges (see θ0 to θ2 in FIG. 12). After that, the results of the calculations are stored in the memory 38b (ST3).

Next, the host controller 38 confirms whether or not it has received a stop command caused by the operation of the user or the like, and determines whether or not to stop sensing (detection operation) (ST4). When a stop command is received, the host controller 38 turns off the power of the drive circuit 40 and terminates the detection operation (ST5). Or, when the stop command has not been received, the host controller 38 returns its operation to the above-described Process 1 and resumes the detection operation.

As described above, when the radii of curvature at the four detected sites are relatively large, the strain gauge sensor device 10 detects the curved surface form of the sample object 50 only by the thinned-out scan detection operation by the strain gauges of Group 1.

Next, the mode of operation when the detection operation is continued will be described.

As shown in FIGS. 9A, 9B, and 11, when at least one of the absolute values of the radii of curvature, r0, r1, r3, and r4 is smaller than the threshold value th0 in the above-described Process 2, the host controller 38 instructs the drive circuit 40 to sequentially scan-drive the strain gauges of Group 2. The selector SEL sequentially scan-drives (sets) strain gauges G1 (Unit 4), G5 (Unit 5), G9 (Unit 6), and G13 (Unit 7) of Group 2 and sequentially reads the detection signals (voltage values) of these strain gauges (Process 3).

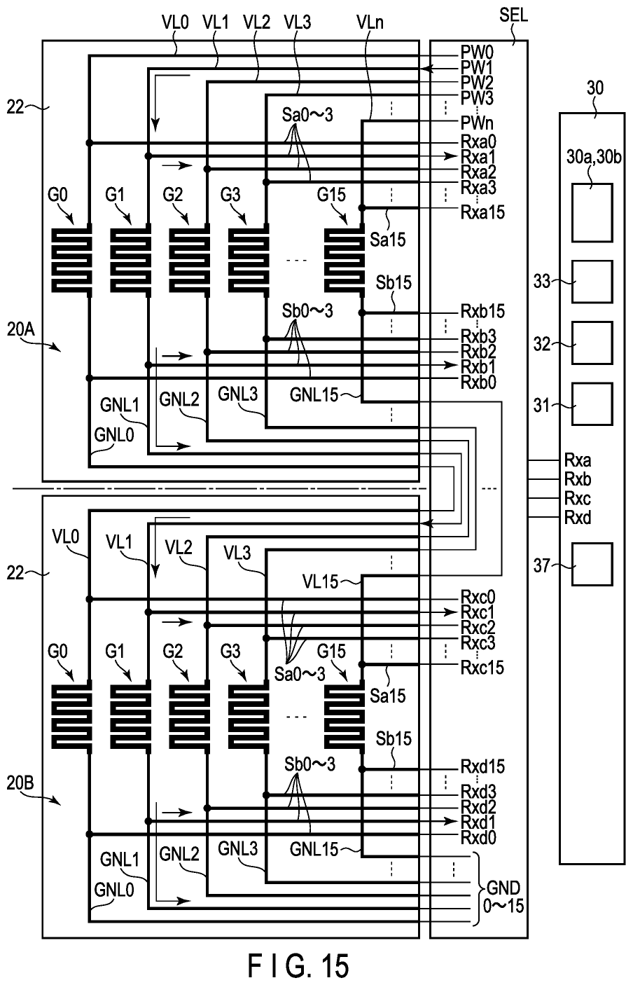

In detail, as shown in FIG. 15, the selector SEL applies the desired voltage PW1 to the power line VL1 of the first sensor sheet 20A. Thus, the current I is allowed to flow in the strain gauge G1 for a certain period of time. At the same time, the selector SEL reads the detection signal (voltage value) RXa1 at one end of the strain gauge G1 and the detection signal (voltage value) RXb1 at the other end of the strain gauge G1 via the first signal line Sal and the second signal line Sb1.

The strain gauge G1 of the first sensor sheet 20A and the strain gauge G1 of the second sensor sheet 20B are connected in series via the ground line GNL1 of the first sensor sheet 20A, the connection line (plated through hole) and the power line VL1 of the second sensor sheet 20B. Therefore, when the strain gauge G1 of the first sensor sheet 20A is scan-driven, the strain gauge G1 of the second sensor sheet 20B is driven synchronously, and the current I is allowed to flow in the strain gauge G1 as well. At the same time, the selector SEL acquires the detection signal (voltage value) RXc1 at one end of the strain gauge G1 and the detection signal (voltage value) RXd1 at the other end of the strain gauge G1 via the first signal line Sal and the second signal line Sb1 of the second sensor sheet 20B.

The acquired detection signals RXa1, RXb1, RXc1, and RXd1 are sent to the analog front end 30, where they are adjusted and differentially detected and then stored in the memory 37.

Thereafter, as in the case described above, the selector SEL sequentially scan-drives the strain gauges G5, G9, and G13 of the first sensor sheets 20A and the second sensor sheets 20B, and the detection signals (voltage values) of these strain gauges, RXa5, RXb5, RXc5, RXd5, RXa9, RXb9, RXc9, RXd9, RXa13, RXb13, RXc13, RXd13 are acquired sequentially. The acquired detection signals RXa, RXb, RXc, and RXd are sent to the analog front end 30, where they are adjusted and differentially detected and then stored in the memory 37.

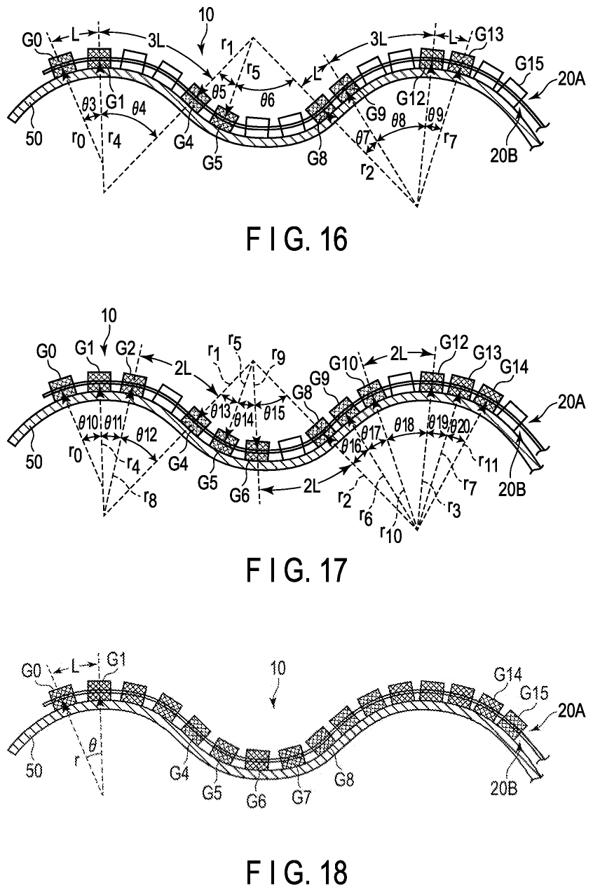

When the scan-driving of the strain gauges of Group 2 is completed, the analog front end 30 reads the differential data for one frame from the memory 37 and outputs it to the host controller 38. FIG. 16 is a diagram schematically showing the strain gauge sensor device in a state where the strain gauges G0, G4, G8, and G12 of Group 1 and the strain gauges G1, G5, G9, and G13 of Group 2 are scan-driven. As shown in FIG. 9A and FIG. 16, the read circuit 38a of the host controller 38 sends the sent differential data to the read arithmetic processing unit 38c. The arithmetic processing unit 38c calculates the radii of curvature, r4, r5, r6, and r7 of the sites detected by the strain gauges G1, G5, G9, and G13 based on the sent differential data (Process 4). The calculation results are stored in the memory 38b.

Next, the determination unit 38d of the host controller 38 compares each of the absolute values of the calculated curvature radii r4, r5, r6, and r7 with the predetermined threshold value th1, and determines whether to continue or stop the scan-driving according to the size relationship in terms of which is greater or smaller (Process 4). In one example, when at least one of the absolute values of the curvature radii r4, r5, r6, and r7 is smaller than the threshold value th1, the host controller 38 instructs the drive circuit 40 to sequentially scan-drive the strain gauges of the next group, Group 3. When the absolute values of all curvature radii r4, r5, r6, and r7 are greater than the threshold value th1, the arithmetic processing unit 38c calculates the curved surface form (curved surface coordinates) of the entire surface of the sample object 50 based on the already calculated curvature radii r0 to r7. More specifically, the absolute values and positive/negative signs of the radii of curvature, r4, r5, r6, and r7 obtained by the above-described formula (2), as well as the interval L between strain gates, are used to obtain the rotation angle between strain gauges. The rotation angle is not only calculated based on the radii of curvature obtained in Group 2, but also based on the radii of curvature obtained in Group 1 and Group 2 (see θ3 to θ9 in FIG. 16). Thereafter, the results of the calculation are stored in the memory 38b (ST6).

Next, the host controller 38 confirms whether or not a stop command has been received, and determines whether or not to stop sensing (detection operation) (ST7). When a stop command is received, the host controller 38 turns off the power of the drive circuit 40 and terminates the sensing operation (ST8). When the stop command has not been received, the host controller 38 returns its operation to the above-described Process 1 and resumes the detection operation.

As described above, when the absolute values of the radii of curvature, r4, r5, r6, and r7 at the four detected sites are relatively large, the strain gauge sensor device 10 detects the curved surface form of the sample object 50 by the thinned-out scan detection operation by the strain gauges of Group 1 and Group 2.

As shown in FIG. 11, FIGS. 9A and 9B, when at least one of the absolute values of the radii of curvature, r4, r5, r6 and r7 is smaller than the threshold value th1 in the above-described Process 4, the host controller 38 instructs the drive circuit 40 to sequentially scan-drive the strain gauges in Group 3. The selector SEL sequentially scan-drives (sets) strain gauges G2 (Unit 8), G6 (Unit 9), G10 (Unit 10), and G14 (Unit 11) of Group 3 and sequentially reads the detection signals (voltage values) of these strain gauges (Process 5). The acquired detection signals RXa, RXb, RXc, and RXd are sent to the analog front end 30, where they are adjusted and differentially detected and then stored in the memory 37.

FIG. 17 is a diagram schematically showing the strain gauge sensor device in a state where the strain gauges G0, G4, G8, and G12 of Group 1, the strain gauges G1, G5, G9, and G13 of Group 2, and the strain gauges G2, G6, G10, and G14 of Group 3 are scan-driven. As shown in FIG. 9B and FIG. 17, the read circuit 38a of the host controller 38 sends the sent differential data to the read arithmetic processing unit 38c. The arithmetic processing unit 38c calculates the radii of curvature, r8, r9, r10, and r11 of the sites detected by the strain gauges G2, G6, G10, and G14 based on the sent differential data (process 6). The calculation results are stored in the memory 38b.

Next, the determination unit 38d of the host controller 38 compares each of the absolute values of the calculated radii of curvature, r4, r5, r6, and r7 with the predetermined threshold value th2, and determines whether to continue or stop the scan-driving according to the size relationship in terms of which is greater or smaller (Process 6). In one example, when at least one of the absolute values of the curvature radii r8, r9, r10, and r11 is smaller than the threshold value th2, the host controller 38 instructs the drive circuit 40 to sequentially scan-drive the strain gauges of the next group, Group 4. Further, when the absolute values of all curvature radii r8, r9, r10, and r11 are greater than the threshold value th2, the arithmetic processing unit 38c calculates the curved surface form (curved surface coordinates) of the entire surface of the sample object 50 based on the detected curvature radii r0 to r11. More specifically, the absolute values and positive/negative signs of each of the radii of curvature, r8, r9, r10, and r11 obtained by the above-provided formula (2), as well as the interval L between strain gates, are used to obtain the rotation angle between the strain gauges. As in the case described above, the rotation angle is not only calculated based on the radii of curvature obtained in Group 3, but also based on the radio of curvature obtained in Groups 1 to 3 (see θ10 to θ20 in FIG. 17). Thereafter, the results of the calculation are stored in the memory 38b (ST9).

Next, the host controller 38 determines whether or not to stop sensing (detection operation) (ST10), and when a stop command is received, the detection operation is terminated by turning off the power of the drive circuit 40 (ST11). Or when the stop command has not been received, the host controller 38 returns its operation to the above-described Process 1 and resumes the detection operation.

Thus, when the detected radii of curvature, r8, r9, r10, and r11 at the four sites are relatively large, the strain gauge sensor device 10 detects the curved surface form of the sample object 50 by the thinned-out scan detection operation by the strain gauges of Groups 1, 2, and 3.

As shown in FIG. 9B, when at least one of the absolute values of the radii of curvature, r8, r9, r10, and r11 is smaller than the threshold value th2 in the above-described Process 6, the host controller 38 instructs the drive circuit 40 to sequentially scan-drive the strain gauges of Group 4. The selector SEL sequentially scan-drives (sets) the strain gauges G3 (Unit 12), G7 (Unit 13), G11 (Unit 14), and G15 (Unit 15) of Group 4 and sequentially reads the detection signals (voltage values) of these strain gauges (Process 7). The acquired detection signals RXa, RXb, RXc, and RXd are sent to the analog front end 30, where they are adjusted and differentially detected and then stored in the memory 37.

FIG. 18 is a diagram schematically showing the strain gauge sensor device in a state where the strain gauges G0 to G15 of Groups 1 to 4 are scan-driven. As shown in FIG. 9B and FIG. 18, the read circuit 38a of the host controller 38 sends the sent differential data to the arithmetic processing unit 38c. The arithmetic processing unit 38c calculates the radii of curvature, r12, r13, r14, and r15 of the sites detected by the strain gauges G3, G7, G11, and G15 based on the sent differential data, and further calculates the curved surface form (curved surface coordinates) of the entire surface of the sample object 50 based on the already calculated curvature radii r0 to r15. More specifically, the absolute value and positive/negative sign of each of the curvature radii r0 to r15 obtained thus far, as well as the interval L between strain gates are used to obtain the rotation angle between the strain gauges. Thereafter, the results of the calculations are stored in the memory 38b (Process 8).

Next, the host controller 38 determines whether or not to stop sensing (detection operation), and when a stop command is received, the detection operation is terminated by turning off the power of the drive circuit 40 (process 8). Or, when the stop command has not been received, the host controller 38 returns its operation to the above-described Process 1 and continues the detection operation.

Thus, when measuring a curved surface with a small radius of curvature, the strain gauge sensor device 10 scan-drives the strain gauges of Groups 1, 2, 3, and 4, that is, all the strain gauges G0 to G15 and thus detects the curved surface form of the sample object 50.

Note that in the detection operation mode described above, the threshold values th0, th1, and th2 for determining the size of the radius of curvature can be set to any value. For example, the threshold values th0, th3, and th2 may be the same as or different from each other. That is, the threshold value th0=the threshold value th1=threshold value th2, or the threshold value th0>the threshold value th1>the threshold value th2, or the threshold value th0<threshold value th1<threshold value th2, will do. It also suffices if only two of these threshold values are the same.

According to the strain gauge sensor apparatus 10 of the first embodiment configured as described above, the thinned-out scan detection is performed by a smaller number of strain gauges than the total number of strain gauges, and for each one time of the thinned-out scan detection, it is determined whether to continue or stop the next thinned-out scan detection. In the curved surface detection operation of a sample object with a relatively large radius of curvature, the curved surface form of the sample object can be detected with a small number of thinned-out scan detections. With this configuration, according to this embodiment, it is possible to obtain a strain gauge sensor device which can shorten the detection time and reduce the power consumption.

Note that in the first embodiment described above, the number of strain gauges in the sensor sheet is not limited to sixteen, but can be increased or decreased as necessary. The number of groups to be driven by the thinned-out scanning is not limited to four, but can be set to any number of two or more. The number of strain gauges in each group is not limited to a number, but can be different from one group to another. The combination of strain gauges in each group is not limited to that discussed in the first embodiment, but can be selected in various ways.

### First Modified Example

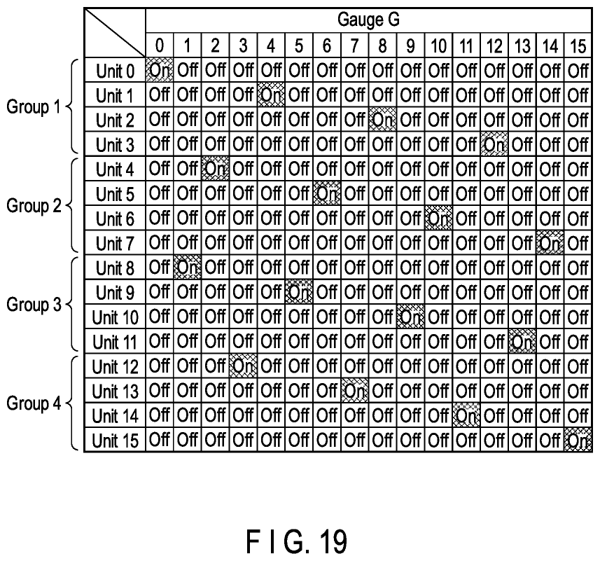

FIG. 19 is a diagram showing the grouping and driving order of the strain gauges in the first modified example when they are scan-driven. As shown in the figure, in the first modified example, the sixteen strain gauges are divided into four groups, Groups 1 to 4, and each group contains four strain gauges. These four strain gauges are strain gauges located at equal intervals from each other, for example, being apart from each other by four strain gauges (4 L).

Group 1 contains strain gauges G0, G4, G8, and G12 which correspond to Units 0 to 3. Group 2 contains strain gauges G2, G6, G10, and G14 corresponding to Units 4 to 7. Group 3 contains strain gauges G1, G5, G9, and G13 corresponding to Units 8 to 11. Group 4 contains strain gauges G3, G7, G11, and G15 corresponding to Units 12 to 15.

According to the first modified example, the distance between the strain gauges in Group 1 and those in Group 2 is set as wide as 2 L, which is equivalent to two strain gauges. With this configuration, by executing the thinned-out scan detection of group 1 and the thinned-out scan detection of group 2, the strain detection can be performed over a wider area in the longitudinal direction X. Other advantageous effects similar to those of the above-described first embodiment can be obtained in Modified Example 1 as well.

### Second Modified Example

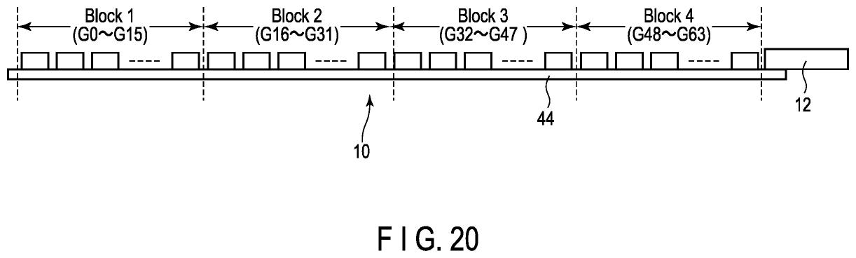

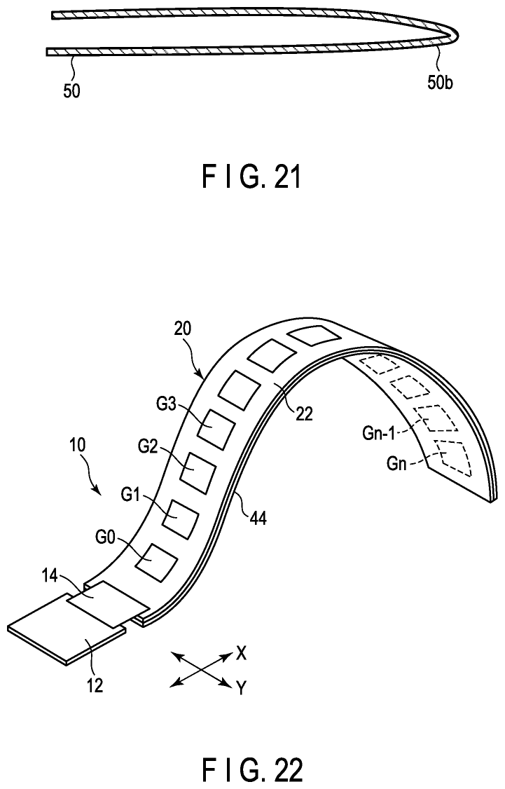

FIG. 20 is a side view schematically showing the strain gauge sensor device according to the second modified example, and FIG. 21 is a cross-sectional view showing an example of the sample object.

As shown in FIG. 20, in the second modified example, the strain gauge sensor device 10 is configured to divide all strain gauges into a plurality of blocks, and further divide the strain gauges in each block into a plurality of groups and drive a thinned-out scan for each group. In detail, the sensor sheet of the strain gauge sensor device 10 includes 64 strain gauges G0 to G63 arranged in a row. When scan-driving the strain gauges, the 64 strain gauges are divided into a plurality, for example, four blocks, Blocks 1 to 4. Further, the strain gauges in each block are divided into a plurality, for example, four groups, Groups 1 to 4. Then, the thinned-out scan detection operation for each group is performed for each block.

In one example, Block 1 contains 16 consecutive strain gauges G0 to G15. Block 2 contains 16 consecutive strain gauges G16 to G31. Block 3 contains 16 consecutive strain gauges G32 to G47. Block 4 contains 16 consecutive strain gauges G48 to G63.

Each of Blocks 1 to 4 is divided into four groups, for example, as in the first embodiment described above, and each group contains four strain gauges. These four strain gauges are located at equal intervals from each other, for example, being apart from each other by four strain gauges (4 L).

In the strain gauge sensor device 10 described above, a thinned-out scan detection operation similar to that of the first embodiment described above is performed for each of Blocks 1 to 4. Let us assume here, for example, a case where a curved surface form is detected by the strain gauge sensor device 10 for a sample object 50 of a hairpin shape including a regionally large bending angle, as shown in FIG. 21. In this case, the areas of Block 1 and Block 4 of the strain gauge sensor device 10 are each installed over a straight portion of the sample object 50 with a large curvature radius, and a part of Block 2 and Block 3 is installed over a curved portion 50b with a small curvature radius. While maintaining this state, a thinned-out scan detection operation is performed for each block. In Block 1 and Block 4, which are installed in the area with a large radius of curvature, the curved surface form of this area is detected by a thinned-out scan detection operation by one or two groups. In Block 2 and Block 3, which are installed in the area with a small radius of curvature, the curved surface form of this area is detected by continuing the thinned-out scan detection operation by multiple groups of three or more.

According to the above second modified example, the thinned-out scan detection operation can be continued multiple times only for the block detecting the curved surface area with a small radius of curvature, and the thinned-out scan detection operation can be discontinued after once or so for the block detecting the curved surface area with a large radius of curvature. With this configuration, it is possible to shorten the detection time of the entire strain gauge sensor device, and at the same time, to reduce the power consumption.

Next, the strain gauge sensor device of the second embodiment will be described. In the second embodiment described below, the same reference symbols as those in the first embodiment described above are designated to the same parts as those of in the first embodiment, and the detailed descriptions thereof may be simplified or omitted.

### Second Embodiment

FIG. 22 is a perspective view of a strain gauge sensor device according to the second embodiment.

As shown in the figure, according to the second embodiment, the strain gauge sensor device 10 constitutes a single-sided type strain gauge sensor. The strain gauge sensor device 10 comprises an elongated strip-shaped flexible base substrate 44, a sensor sheet 20 attached onto one side of the base substrate 44, and a relay substrate (drive circuit board) 12 connected to the sensor sheet 20 via a flexible circuit board (FPC) 14.

The sensor sheet 20 is configured in a fashion similar to that of the first sensor sheet or the second sensor sheet in the first embodiment described above. That is, the sensor sheet 20 includes an elongated strip-shaped flexible sheet substrate 22 and a conductor pattern provided on one side of the sheet substrate 22. The conductor pattern includes a plurality of strain gauges G0 to Gn. The plurality of strain gauges G0 to Gn are arranged in a row along the longitudinal direction X at predetermined intervals from one end of the sheet base material 22 to the other end in the longitudinal direction X.

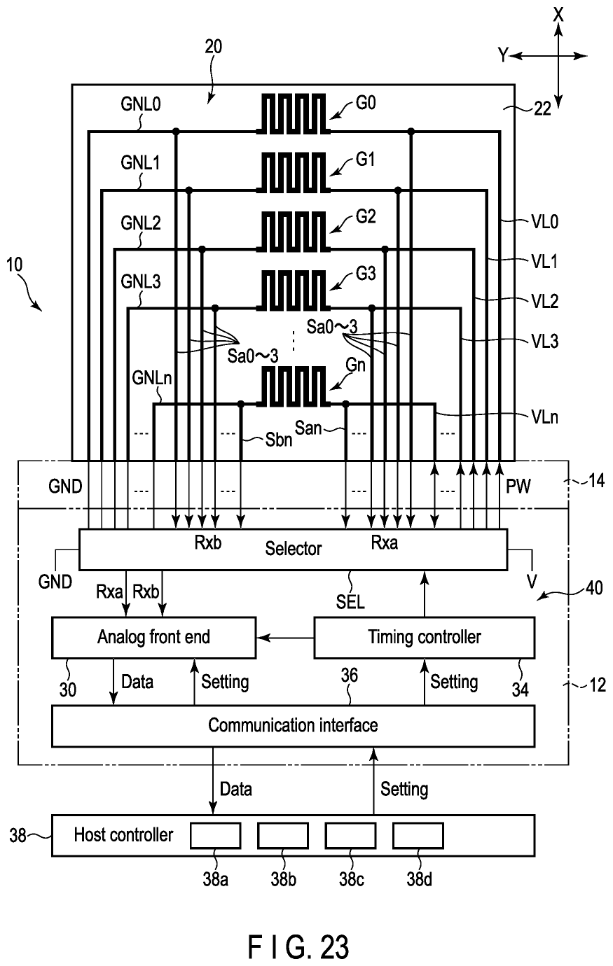

FIG. 23 is a diagram schematically showing the strain gauges and wiring patterns of the sensor sheet 20 and the controller of the strain gauge sensor device 10.

As shown in the figure, a plurality of strain gauges G0 to Gn of the sensor sheet 20 are arranged in a row so as to be spaced apart from each other along the longitudinal direction X of the sensor sheet 20. Each of the strain gauges G0-Gn extends in a bellows fashion along the width direction Y and includes one end and the other end along the width direction Y. Each of the strain gauges G0 to Gn creates a change in resistance in response to strain. The conductor pattern includes a plurality of power lines VL0 to VLn, a plurality of ground lines GNL0 to GNLn, a plurality of first signal lines Sa0 to San, and a plurality of second signal lines Sb0 to Sbn, each extending in the longitudinal direction X along a row of the strain gauges G0 to Gn.

The power lines VL0 to VLn each have one end connected to one end of the respective one of the strain gauges G0 to Gn and the other end located at the proximal end of the sheet base material 22, and extend substantially parallel to each other. The first signal lines Sa0 to San are located between one end side of the respective strain gauges G0 to Gn and the power supply lines VL0 to VLn. The first signal lines Sal to San each include one end connected to one end side of each respective one of the strain gauges G0 to Gn and the other end located at the proximal end of the sheet base material 22, and extend substantially parallel to each other.

The ground lines GNL0 to GNLn are located on the other end side of the strain gauges G0 to Gn. The ground lines GNL0 to GNLn each include one end connected to the other end side of each respective one of the strain gauges G0 to Gn and the other end located at the proximal end side of the sheet base material 22, and extend substantially parallel to each other.

The second signal lines Sb0 to Sbn are located between the other end side of the respective strain gauges G0 to Gn and the ground lines GNL0 to GNLn. The second signal lines Sb0 to Sbn each include one end connected to the other end side of each respective one of the strain gauges G0 to Gn and the other end located at the proximal end of the sheet base material 22, and extend substantially parallel to each other.

The drive circuit (controller) 40 that drives the sensor sheet 20 includes a selector SEL, an analog front end (AFE: signal adjustment circuit) 30, a timing controller 34, a communication interface 36 and the like. The communication interface 36 is connected wirelessly or by wire to an external host controller 38 and receives drive signals (setting) from the host controller 38 and transmits detection data (Data) to the host controller 38. The configuration of each part of the drive circuit 40 and that of the host controller 38 are substantially the same as those of the drive circuit and the host controller in the first embodiment described above.

According to this embodiment, the strain gauge sensor device 10 divides all strain gauges G0-G15 into two or more multiple groups, and executes curved surface detection in the so-called thinned-out scan operation mode, in which a plurality of strain gauges are scan-driven (time-divisionally driven) for each group to acquire detection values. The grouping of the strain gauges may be the same as that of the first embodiment described above, or it may be different grouping. The host controller 38 calculates the radius of curvature of the detected area each time the thinned-out scan-drive of strain gauges is carried out for one group and compares it with a threshold value to determine whether to continue or discontinue and stop the scan-drive. When the calculated curvature radius of each site is greater than the threshold value, the host controller 38 stops the scan detection operation and calculates the curved surface form of the sample object based on the calculated curvature radius. Otherwise, the strain gauge sensor device 10 performs strain detection by a scan detection operation similar to that of the first embodiment.

With the single-sided strain gauge sensor device 10 of the second embodiment, which is configured as described above, advantageous effects similar to those of the strain gauge sensor device of the first embodiment described above can be obtained. In other words, in the second embodiment, it is possible to obtain a strain gauge sensor device which can shorten the detection time and reduce the power consumption.

While certain embodiments and variations have been described, these embodiments and variations have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

All configurations that can be implemented by a person skilled in the art based on each of the above-described configurations as embodiments of the invention, with appropriate design changes, are also within the scope of the invention, as long as they encompass the gist of the invention.

For example, the direction in which the strain gauges are scan-driven is not limited to the direction from the strain gauge G0 on the distal end side to the strain gauge Gn on the proximal end side, but may be in the opposite direction, from the strain gauge Gn on the proximal end side to the strain gauge G0 on the distal end side. Further, the number of strain gauges arranged on the sensor sheet is not limited to those of the above-described embodiments, but can be selected arbitrarily. As mentioned above, the grouping and blocking of strain gauges is not limited to those of the above-described embodiment, but can be selected in various ways. The materials, dimensions, and shape which constitute the sensor sheet are not limited to those of the above-described embodiments, but can be changed as needed.

What is claimed is:

1. A strain detection device comprising:
a sensor sheet comprising a plurality of strain gauges provided in a row at intervals, a plurality of power lines and a plurality of first signal lines each connected to one end side of a respective one of the plurality of strain gauges, and a plurality of ground lines and a plurality of second signal lines each connected to an other end side of the respective one of the plurality of strain gauges; and
a controller comprising a selector which sequentially scan-drives the plurality of strain gauges via the plurality of power lines and sequentially reads detection signals at the one end side of the respective strain gauges and detection signals at the other end side of the respective strain gauges via the first signal lines and the second signal lines, an arithmetic processor which calculates a radius of curvature based on the detection signals, and a determination unit which determines whether to stop or continue scan-driving of the strain gauges based on the radius of curvature.

2. The device of claim 1, wherein
the controller sequentially scan-drives a plurality of strain gauges among the strain gauges, determines whether the detection value of each strain gauge is greater than a predetermined threshold value, sequentially scan-drives other plurality of strain gauges to obtain the detection value when the value is smaller than the threshold value, and stops the scan-driving when larger than the threshold value, and calculates a curved surface form based on the detection values acquired until the stopping.

3. The device of claim 1, wherein
the controller divides the plurality of strain gauges into at least two groups and sequentially scan-drives the plurality of strain gauges for each group, calculates the radius of curvature based on the detection values of the strain gauges, and when all of the radii of curvature calculated are greater than a predetermined threshold value, stops the scan-driving and calculate the curved surface form based on the radii of curvature calculated, and when at least one of the calculated radii of curvature is smaller than the threshold value, sequentially scan-drive a plurality of strain gauges the strain gauges of an other group and calculate the radius of curvature based on the detection value of each strain gauge.

4. The device of claim 3, wherein
the plurality of strain gauges in each of the groups are located to be apart from each other by two or more strain gauges.

5. The device of claim 4, wherein
the plurality of strain gauges in each of the groups are located to be apart from each other at equal intervals.

6. The device of claim 1, wherein
the controller sets up a plurality of blocks each containing a plurality of consecutive strain gauges, divides the strain gauges of each block into a plurality of groups each containing a plurality of strain gauges spaced apart from each other, and in each of the blocks, sequentially scan-drives a plurality of strain gauges of the strain gauges for each group and calculates the radius curvature based on the detection value of each of the strain gauges, and when all of the radii of curvature calculated are greater than a predetermined threshold value, stops the scan-driving, and calculates the curved surface form based on the radii of curvature calculated, and when at least one of the radii of curvature calculated is less than the threshold value, sequentially scan-drives a plurality of strain gauges of the strain gauges of an other group and calculates the radius of curvature based on the detection value of each of the strain gauges.
